(19) United States
(12) Patent Application Publication
(10) Pub. No.: US 2026/0295745 A1
(43) Pub. Date: Oct. 1, 2026

(54) VACUUM SUCTION APPARATUS FOR MACHINE TOOL

(71) Applicant: DN SOLUTIONS CO., LTD., Changwon (KR)

(72) Inventor: Jooyoung JUNG, Changwon (KR)

(21) Appl. No.: 19/477,277

(22) PCT Filed: Mar. 21, 2024
(86) PCT No.: PCT/KR2024/095601

§ 371 Date: Oct. 21, 2025

(30) Foreign Application Priority Data
May 3, 2023 (KR) 10-2023-0057520

(51) Int. Cl. B23Q 3/08; B23Q 11/00; B23Q 11/10

(52) U.S. Cl. CPC B23Q 3/088; B23Q 11/0067; B23Q 11/1069; B23Q 2703/04

(57) ABSTRACT

A vacuum suction apparatus for a machine generates negative pressure using compressed air, and when the negative pressure is applied, suctions and holds a workpiece using a suction plate, and effectively removes foreign substances such as a coolant oil and fine chips generated during a machining process of the workpiece using the compressed air. The vacuum suction apparatus controls a plurality of solenoid valves to discharge the foreign substances collected in the process of suctioning the workpiece, thereby securely suctioning and holding a precise workpiece with a high surface roughness, and effectively removing the coolant oil or the fine chips suctioned into the vacuum suction apparatus to prevent damage to the workpiece, and further prevent performance degradation or damage to the vacuum suction apparatus.

### TECHNICAL FIELD

The present disclosure relates to a vacuum suction apparatus for a machine tool which holds a workpiece through a vacuum suction, and more specifically, to a vacuum suction apparatus which holds a workpiece by the vacuum suction using a negative pressure and effectively removes foreign substances such as a coolant oil generated during a machining process of the workpiece.

### BACKGROUND ART

In general, in case of processing a plate-shaped precision workpiece with a high surface roughness such as a Liquid Crystal Display (LCD) substrate or a semiconductor-related material, when the workpiece is held with a clamp device used in a conventional machine tool, a workpiece surface may be damaged or a precise positioning of the workpiece may be difficult to perform.

To overcome these problems, a workpiece holding device in a vacuum suction manner using negative pressure has been used. In such a vacuum suction apparatus, foreign substances such as a coolant oil or fine chips generated during the machining process are attached to the workpiece during a vacuum suction process to damage the workpiece, or suctioned into an interior of the vacuum suction apparatus to deteriorate its performance or to cause damage thereto.

In addition, the vacuum suction apparatus for the workpiece needs to adjust its suction force to protect a workpiece surface, depending on a shape of the workpiece as an object to be suctioned, a precision degree of a suction surface or a material of the workpiece.

Patent document 1 (Korean Patent Publication No. 10-1254872), which is introduced as a prior art, discloses a suction apparatus with a structure in which vacuum suction holes with different diameters are formed in a vacuum suction panel, and a residue removal hole is provided on opposite sides of the vacuum suction hole to suction residues generated in a polishing process using a vacuum pressure.

However, such a structure has limitations in controlling a suction pressure because it cannot control the suction pressure in any other way than by providing vacuum suction holes with different diameters to protect a protruding pattern shape on a surface to be suctioned, such as an LCD substrate. In addition, since a separate residue removal hole should be provided to suction the residues generated during the polishing process, the structure becomes complicated. As the residue removal hole and the vacuum suction hole are configured separately, foreign substances may enter inside the suction apparatus through the vacuum suction hole during a suction process of the object to be suctioned, but there is no suggestion as to how to remove the foreign substances being entered.

Patent Document 2 (Korean Patent Publication No. 10-2134876) discloses a vacuum suction apparatus which includes a negative pressure body generating negative pressure, a fixed frame receiving the negative pressure transmitted from the negative pressure body, a negative pressure port connected to the fixed frame, a suction panel connected to the negative pressure port, and a sealing member maintaining an airtightness of a connection portion, which adjusts a suction pressure of the suction panel by selectively controlling first and second control valves through a control module.

Such a structure is designed for suctioning and moving a workpiece with a rough surface such as an iron plate or marble, and there is no suggestion to precisely hold the workpiece without damaging a workpiece surface for machining the workpiece such as a precision substrate, and to protect the workpiece from the foreign substances such as a coolant oil or fine chips generated during the machining operation in order to protect the suction apparatus.

Patent Document 3 (Korean Patent Publication No. 10-1518180) discloses a vacuum suction workbench using high-pressure air in which a vacuum forming module and a vacuum releasing module operated by solenoid valves are integrally connected to a manifold, thereby reducing an operating noise of a high-pressure pump and facilitating repair or replacement operations thereof. In addition, the workbench is provided with a pressurizing body that pressurizes an uneven surface to hold a workpiece having a step portion. However, the suction apparatus of Patent Document 3, like Patent Document 2, fails to propose a solution for precisely holding the workpiece such as a precision-substrate without damaging its surface during a machining process, protecting the workpiece from the foreign substances such as the coolant oil or the fine chips generated during the machining process, and protecting the suction apparatus itself.

### DISCLOSURE OF INVENTION

### Technical Problem

To resolve the problems discussed above, an object of the present disclosure is to provide a vacuum suction apparatus that securely hold a workpiece without damaging a workpiece surface by adjusting a suction force in a workpiece holding device in a vacuum suction manner using negative pressure, protects a workpiece suction surface from foreign substances such as a coolant oil or fine chips generated during a machining process of the workpiece, and effectively removes the foreign substances suctioned into the vacuum suction apparatus.

### Technical Solution

To achieve the objects discussed above, a vacuum suction apparatus for a machine tool of the present disclosure comprises:
a suction plate that suctions a workpiece using a vacuum pressure;
a pneumatic pump that supplies compressed air through a compressed air line;
a vacuum generator that generates negative pressure by discharging the compressed air to an outside at one end portion of the compressed air line;
a vacuum solenoid valve that is installed on the compressed air line between the pneumatic pump and the vacuum generator to selectively connect or disconnect a flow path of the compressed air to be supplied to the vacuum generator;
a vacuum tank having an internal volume and connected to the vacuum generator through a vacuum line;
a first solenoid valve installed on a suction plate line that connects the vacuum tank and the suction plate, and configured to selectively connect the suction plate line to a high-pressure vacuum or a low-pressure vacuum;
a drain tank connected to the suction plate through a drain line to collect coolant oil and fine chips from the suction plate using the vacuum pressure;
a second solenoid valve installed on the suction plate line that connects the first solenoid valve and the suction plate, and configured to selectively connect the suction plate line to the suction plate or the drain tank;
a third solenoid valve installed on a drain tank vacuum line that connects the second solenoid valve and the drain tank, and configured to connect or disconnect the drain tank vacuum line;
a fourth solenoid valve installed on a drain line that connects the suction plate and the drain tank, and configured to selectively connect or disconnect the drain line;
   a fifth solenoid valve installed on a discharge line that connects the drain tank to the outside, and configured to selectively connect or disconnect the discharge line;
   a sixth solenoid valve installed on an unclamp line that connects the compressed air line to the suction plate, and configured to selectively connect or disconnect the unclamp line;
   a vacuum release solenoid valve installed between the vacuum line and the compressed air line, and configured to connect the vacuum line with the discharge line through a bypass discharge line and simultaneously with the compressed air line, and selectively connect or disconnect the compressed air line and the vacuum line;
   a control unit electrically connected to the first to sixth solenoid valves and the vacuum release solenoid valve, respectively, and configured to connect or disconnect a flow of the compressed air or the vacuum pressure, or to change a flow direction thereof by switching the said solenoid valves; and an operating unit that provides an operating command to the control unit.

As a preferred embodiment, a high-pressure vacuum pressure reducing valve that connects the suction plate line with the vacuum tank to form a high-pressure vacuum, and a low-pressure vacuum pressure reducing valve that connects the suction plate line with the vacuum tank to form a low-pressure vacuum depending on a switching position of the first solenoid valve are respectively installed on the suction plate line between the vacuum tank and the first solenoid valve.

As a preferred embodiment, a first filter that collects the coolant oil and the fine chips suctioned from the suction plate through the suction plate line is installed on the suction plate line between the second solenoid valve and the suction plate, wherein a lower portion of the first filter is connected to the discharge line connected to the outside through the bypass discharge line.

As a preferred embodiment, a second filter that collects the coolant oil and the fine chips is installed on the drain tank vacuum line that connects the third solenoid valve and the drain tank, wherein a lower portion of the second filter is connected to the discharge line to be selectively connected to the outside.

As a preferred embodiment, the lower portion of the second filter is connected to an upstream side of the fifth solenoid valve that selectively connects or disconnects the discharge line to the outside.

As a preferred embodiment, the fourth solenoid valve closes the drain line connected to the suction plate to maintain the vacuum pressure formed in the suction plate when the drain tank is communicated to the outside through the fifth solenoid valve.

As a preferred embodiment, the fifth solenoid valve closes the discharge line to maintain a vacuum pressure in the drain tank while the drain tank collects the coolant oil and the fine chips from the suction plate through the drain line, and when discharging the coolant oil and the fine chips collected in the drain tank to the outside, the fifth solenoid valve connects the discharge line to the outside so that the collected coolant oil and the fine chips are discharged to the outside by the compressed air applied to the drain tank.

As a preferred embodiment, the sixth solenoid valve is opened (connected) when the compressed air is sprayed to remove the foreign substances from the suction plate while the vacuum pressure is released from the suction plate, and is closed (disconnected) when the vacuum pressure is formed in the suction plate.

As a preferred embodiment, the vacuum suction apparatus further comprises:
a seventh solenoid valve installed on a drain pressurized line that connects the compressed air line and the drain tank, and configured to selectively connect or disconnect the drain pressurized line;
an ejector connected to the compressed air line through an ejector line, and configured to discharge the compressed air to the outside to generate negative pressure and to supply the generated negative pressure to the drain tank vacuum line through a second vacuum line; and
an eighth solenoid valve installed on the ejector line to selectively connect or disconnect the ejector line.

As a preferred embodiment, when discharging the coolant oil and the foreign substances collected in the drain tank, the seventh solenoid valve connects the drain pressurized line with the compressed air line so that the compressed air supplied from the compressed air line is applied to the drain tank, and when forming the vacuum pressure in the drain tank, the seventh solenoid valve disconnects the drain pressurized line from the compressed air line.

As a preferred embodiment, when a negative pressure is generated in the ejector, a second vacuum line applies the negative pressure to the drain tank vacuum line, thereby forming or maintaining the negative pressure in the drain tank connected to the drain tank vacuum line.

As a preferred embodiment, a silencer is installed in the vacuum generator and the ejector to reduce noise generated by the compressed air being discharged.

As a preferred embodiment, the control unit and the operation unit comprise at least a low-pressure suction mode that provides a low-pressure vacuum to the suction plate, a high-pressure suction mode that provides a high-pressure vacuum to the suction plate, a chip discharge mode that sprays the compressed air to the suction plate, and a suction termination mode that blocks the vacuum pressure being applied to the suction plate to terminate a workpiece suction operation.

As a preferred embodiment, the operation unit further includes a drain mode that discharges the foreign substances collected in the drain tank.

As a preferred embodiment, the drain mode includes an automatic mode that is automatically executed in a suction mode of the workpiece using the vacuum and a manual mode that is executed by manually operating the operation unit.

As a preferred embodiment, a level sensor is installed in the drain tank to detect a flow rate of the collected coolant oil and provide the same to the control unit, and the control unit is configured to control a drain operation to automatically discharge the coolant oil in the drain tank in a case that the flow rate of the coolant oil provided from the level sensor reaches a predetermined flow rate.

As a preferred embodiment, a pressure sensor is installed on the suction plate line connected to the suction plate or the drain line to detect the vacuum pressure formed in the suction plate and to provide the same to the control unit, and the control unit is configured to stop an operation of the pneumatic pump in a case that a vacuum pressure provided from the pressure sensor reaches a predetermined vacuum pressure.

As a preferred embodiment, a relief valve is installed on the vacuum line to connect the vacuum line to the outside to protect the vacuum line in a case that a vacuum pressure greater than a predetermined vacuum pressure is formed in the vacuum line.

As a preferred embodiment, a check valve is installed on the vacuum line, the suction plate line, the second vacuum line, and the bypass discharge line to prevent a reverse flow of the vacuum or the compressed air.

### Advantageous Effects

The present disclosure may securely suction and hold a precision workpiece with a high surface roughness in a vacuum suction manner using a negative pressure.

In addition, the present disclosure may handle various types and shapes of the workpiece to be held by adjusting a suction pressure as needed.

The present invention may effectively remove foreign substances such as a coolant oil and fine chips generated during a machining process of the workpiece, thereby preventing damage to the workpiece and further preventing the foreign substances from being suctioned into the vacuum suction apparatus to deteriorate a performance of the vacuum suction apparatus or to damage the same.

### DESCRIPTION OF DRAWINGS

FIG. 1 is a pneumatic circuit diagram of a vacuum suction apparatus according to an exemplary embodiment of the present disclosure.

FIG. 2 is a control state table of solenoid valves for each operating mode of a vacuum suction apparatus according to an exemplary embodiment of the present disclosure.

FIG. 3 is a pneumatic circuit diagram of a vacuum suction preparation step according to an exemplary embodiment of the present disclosure.

FIG. 4 is a pneumatic circuit diagram of a low-pressure vacuum suction mode according to an exemplary embodiment of the present disclosure.

FIG. 5 is a pneumatic circuit diagram of a high-pressure vacuum suction mode according to an exemplary embodiment of the present disclosure.

FIG. 6 is a pneumatic circuit diagram of a vacuum suction termination mode according to an exemplary embodiment of the present disclosure.

FIG. 7 is a pneumatic circuit diagram of a chip discharge mode of a vacuum suction apparatus according to an exemplary embodiment of the present disclosure.

FIG. 8 is a control state table of solenoid valves for a drain operation of a vacuum suction apparatus according to an exemplary embodiment of the present disclosure.

FIG. 9 is a pneumatic circuit diagram of a coolant oil discharge operation (a first step) by a drain operation of a vacuum suction apparatus according to an exemplary embodiment of the present disclosure.

FIG. 10 is a pneumatic circuit diagram of a vacuum state transition operation (a second step) of a drain tank after completion of a coolant oil discharge operation by a drain operation of a vacuum suction apparatus according to an exemplary embodiment of the present disclosure.

FIG. 11 is a pneumatic circuit diagram of a drain completion operation (a third step) after a vacuum state transition operation of a drain tank in a drain operation of a vacuum suction apparatus according to an exemplary embodiment of the present disclosure.

FIG. 12 is a pneumatic circuit diagram of a filter drain operation (a fourth step) after completion of a drain in a drain operation of a vacuum suction apparatus according to an exemplary embodiment of the present disclosure.

### BEST MODE FOR EMBODIMENT OF INVENTION

The following description is merely exemplary in nature and is not intended to limit the present disclosure, application, or uses. It should be understood that throughout the drawings, corresponding reference numerals indicate like or corresponding units and features.

In exemplary embodiments of the present disclosure below, the expression of “negative pressure”, “vacuum”, and “vacuum pressure” means a pressure lower than atmospheric pressure. The word “hold” or “suction” means an action of contacting a workpiece 12 with a suction plate 11 using a pressure lower than atmospheric pressure.

In relation to solenoid valves, “switch” and “convert” are used with the same meaning, and means that a spool inside the solenoid valve moves from one direction to the other direction so that an internal flow path is changed (connect or disconnect, or changing the internal flow path).

Furthermore, “open (connect)” of the solenoid valve means a state in which an inlet and an outlet of the internal flow path of the solenoid valve can be communicated with each other, and “closed (disconnect)” means a state in which the inlet and the outlet of the internal flow path of the solenoid valve cannot be communicated with each other.

In addition, “On” of a solenoid valve means that power is supplied to the solenoid valve and the spool is switched in one direction to connect or disconnect the internal flow path, or to change the internal flow path thereof, and “Off” means that power is not supplied to the solenoid valve and the spool returns to or is maintained in a state before operation.

Meanwhile, depending on a type of the solenoid valve, the internal flow path may be “disconnected” when the solenoid valve is “On”, or “connected” when the solenoid valve is “Off”′ or vice versa.

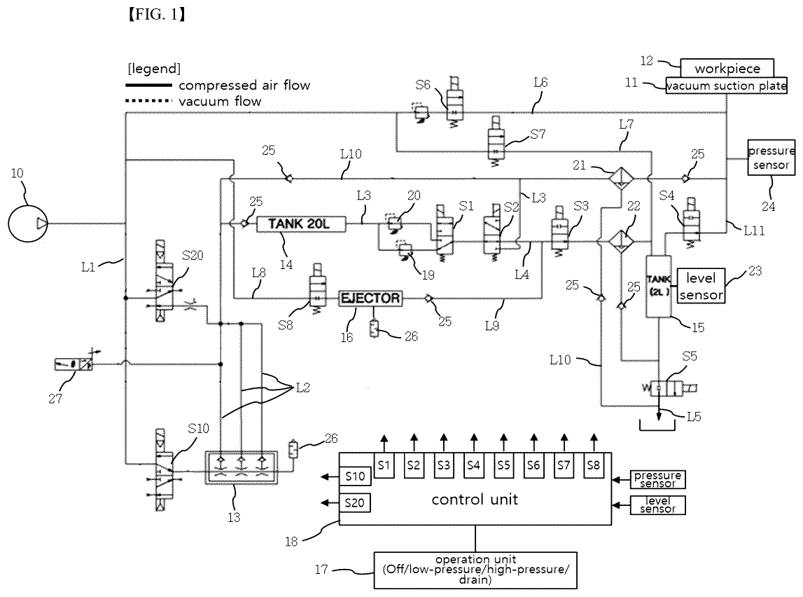

Hereinafter, exemplary embodiments of the present disclosure will be described in detail with reference to FIG. 1 to FIG. 12.

Referring to FIG. 1, a vacuum suction apparatus of the present disclosure may include a suction plate 11 that holds a workpiece 12 using vacuum in a machining area of a machine tool.

Furthermore, the vacuum suction apparatus may include a pneumatic pump 10 that supplies high-pressure compressed air through a compressed air line L1. A vacuum generator 13 may be provided at one end of the compressed air line L1 that generates negative pressure by rapidly passing the compressed air supplied from the pneumatic pump 10 through a narrow tube and discharging the same to the outside. A silencer 26 may be installed at a compressed air discharge portion of the vacuum generator 13 to reduce noise caused by the compressed air being discharged.

A vacuum solenoid valve S10 may be installed on the compressed air line L1 between the pneumatic pump 10 and the vacuum generator 13 to selectively open or close a compressed air flow path supplied to the vacuum generator 13.

The vacuum generator 13 may be connected to a vacuum tank 14 via a vacuum line L2 so that a generated vacuum pressure is applied to the vacuum tank 14 having a predetermined internal volume.

The vacuum tank 14 may be connected to the suction plate 11 via a suction plate line L3 that holds a workpiece 12 using the vacuum. A first solenoid valve S1 may be installed on the suction plate line L3 and may be switched to selectively connect the suction plate 11 to the vacuum tank 14 at a high vacuum pressure or a low vacuum pressure.

On the suction plate line L3 between the vacuum tank 14 and the first solenoid valve S1, a high-pressure vacuum pressure reducing valve 19 to which the suction plate line L3 is connected to form a high-pressure vacuum may be installed, and a low-pressure vacuum pressure reducing valve 20 to which the suction plate line L3 is connected to form a low-pressure vacuum may be installed, depending on a switching position of the first solenoid valve S1.

A drain tank 15 may be installed below the suction plate 11 and is connected to the suction plate 11 via a drain line L11 to collect coolant oil and fine chips from the suction plate 11 using the vacuum pressure.

A second solenoid valve S2 may be installed on the suction plate line L3 that connects the first solenoid valve S1 and the suction plate 11, which connects the suction plate line L3 to the suction plate 11, or to connect the suction plate line L3 to a drain tank vacuum line L4 connected with the drain tank 15.

Therefore, it would be noted that the second solenoid valve S2 may allow the vacuum pressure of the vacuum tank 14 to be selectively applied to the suction plate 11 via the suction plate line L3 or to the drain tank 15 via the drain tank vacuum line L4.

In addition, on the suction plate line L3 that connects the second solenoid valve S2 and the suction plate 11, a first filter 21 may be installed to collect the coolant oil and the fine chips suctioned from the suction plate 11 through the suction plate line L3, and a lower portion of the first filter 21 may be connected to a discharge line L5 that is connected to the outside through a bypass discharge line L10.

A third solenoid valve S3 for connecting or disconnecting the drain tank vacuum line L4 may be installed on the drain tank vacuum line L4 that connects the second solenoid valve S2 and the drain tank 15. Accordingly, when the third solenoid valve S3 is Off to close the flow path, the drain tank 15 may stop forming a vacuum pressure through the vacuum tank 14, and when the third solenoid valve S3 is On to open the flow path, the drain tank 15 may form the vacuum pressure through the vacuum tank 14.

A second filter 22 may be installed on the drain tank vacuum line L4 that connects the third solenoid valve S3 and the drain tank 15 to collect the coolant oil and the fine chips suctioned through the drain tank 15. The lower portion of the second filter 22 may be connected to the discharge line L5 so as to be selectively communicated with the outside. Preferably, the lower portion of the second filter 22 may be connected to an upstream side of a fifth solenoid valve S5 that selectively connects or disconnects the discharge line L5 to the outside. Therefore, the second filter 22 may discharge the foreign substances to the outside through the discharge line L5 only when the fifth solenoid valve S5 is On (open), but when the fifth solenoid valve S5 is Off (closed), the foreign substances may not be discharged to the outside.

A fourth solenoid valve S4 for selectively connecting or disconnecting the drain line L11 may be installed on the drain line L11 that connects the suction plate 11 and the drain tank 15. The fourth solenoid valve S4 may maintain the vacuum pressure formed in the suction plate 11 by disconnecting the drain line L11 connected to the suction plate 11 when the drain tank 15 is communicated with the outside through the fifth solenoid valve S5.

A lower portion of the drain tank 15 may be connected with the discharge line L5 that communicates with the outside. The fifth solenoid valve S5 that selectively connects or disconnects the discharge line L5 may be installed in the discharge line L5. The fifth solenoid valve S5 may disconnect the discharge line L5 to maintain the vacuum pressure in the drain tank 15 while the coolant oil and the fine chips from the suction plate 11 are collected in the drain tank 15 through the drain line L11. Meanwhile, when the coolant oil and the fine chips collected in the drain tank 15 are discharged to the outside, the fifth solenoid valve S5 may connect the discharge line L5 to the outside so that the collected coolant oil and the fine chips are discharged to the outside by the compressed air applied to the drain tank 15.

Meanwhile, the compressed air line L1 may be connected to the suction plate 11 through an unclamp line L6. A sixth solenoid valve S6 may be installed on the unclamp line L6 to selectively connect or disconnect the unclamp line L6. The sixth solenoid valve S6 may be connected in a case that the compressed air is sprayed to remove the foreign substances from the suction plate 11 while the vacuum pressure is released from the suction plate 11, and may be disconnected when the vacuum pressure is formed on the suction plate 11.

Furthermore, the compressed air line L1 may be connected to the drain tank 15 through a drain pressing line L7. A seventh solenoid valve S7 may be installed on the drain pressing line L7 to selectively connect or disconnect the drain pressing line L7. The seventh solenoid valve S7 may connect the drain pressurization line L7 so that the compressed air supplied from the compressed air line L1 may be applied to the drain tank 15 when the coolant oil and the foreign substances collected in the drain tank 15 are to be discharged. Meanwhile, the seventh solenoid valve S7 may disconnect the drain pressing line L7 from the compressed air line L1 when the vacuum pressure is to be formed in the drain tank 15.

The compressed air line L1 may be connected to an ejector 16 that generates negative pressure by discharging the compressed air to the outside through an ejector line L8. An eighth solenoid valve S8 that selectively connects or disconnects the ejector line L8 may be installed on the ejector line L8. One side of the ejector 16 may be connected to the drain tank vacuum line L4 through a second vacuum line L9. Therefore, when negative pressure occurs in the ejector 16, the second vacuum line L9 may provide the negative pressure to the drain tank vacuum line L4 so that the negative pressure may be formed or maintained in the drain tank 15 connected to the drain tank vacuum line L4.

Accordingly, after the vacuum has been released from the drain tank 15 to discharge the coolant oil and the foreign substances, the eighth solenoid valve S8 may enable the drain tank 15 to be converted again to a vacuum state by the ejector 16 without relying on the vacuum tank 14.

In addition, a silencer 26 may be installed in the ejector 16 to reduce noise when the compressed air is discharged to the outside.

Meanwhile, the vacuum line L2 may be connected to both the discharge line L5 communicated with the outside via the bypass exhaust line L10 and the compressed air line L1. A vacuum release solenoid valve S20 may be installed between the compressed air line L1 and the vacuum line L2 to selectively connect or disconnect the compressed air line L1 and the vacuum line L2. Accordingly, the vacuum release solenoid valve S20 may break a vacuum function of the vacuum line L2 when the compressed air line L1 is connected to the vacuum line L2, and may allow the compressed air to be discharged to the outside through the discharge line L5 via the bypass discharge line L10 and the first filter 21. Meanwhile, the vacuum release solenoid valve S20 may provide the negative pressure generated in the vacuum generator 13 to the vacuum tank 14 through the vacuum line L2 by disconnecting the compressed air line L1 and the vacuum line L2.

The vacuum suction apparatus of the present disclosure may include a control unit 18 that is electrically connected to the solenoid valves S1 to S8, S10 and S20 and connects or disconnects the flow of compressed air or a vacuum pressure or changes a flow direction thereof by switching the solenoid valves S1 to S8, S10 and S20). Further, the vacuum suction apparatus may include an operation unit 17 that provides operation commands to the control unit 18.

The control unit 18 and the operation unit 17 may include at least a low-pressure suction mode that provides a low-pressure vacuum pressure to the suction plate 11, a high-pressure suction mode that provides a high-pressure vacuum pressure to the suction plate 11, a chip discharge mode that sprays the compressed air to the suction plate 11 to remove the chips, and a suction termination mode that terminates suction operation of the workpiece 12 by blocking the vacuum pressure being applied to the suction plate 11.

Additionally, the operation unit 17 may further include a drain mode that discharges the foreign substances from the drain tank 15. The drain mode may be operated automatically or manually.

Meanwhile, a level sensor 23 may be installed in the drain tank 15 to detect a flow rate of the coolant oil collected therein and to provide the same to the control unit 18. The control unit 18 may selectively control the solenoid valves S1 to S8, S10 and S20 to automatically perform a drain operation to discharge the coolant oil in the drain tank 15 when the flow rate of the coolant oil provided from the level sensor 23 reaches a predetermined flow rate.

In addition, a pressure sensor 24 may be installed on the suction plate line L3 or on the drain line L11 connected to the suction plate 11 to detect the vacuum pressure formed on the suction plate 11 and provide the same to the control unit 18. The control unit 18 may stop an operation of the pneumatic pump 10 when the vacuum pressure provided from the pressure sensor 24 reaches a predetermined vacuum pressure.

Further, a relief valve 27 may be installed in the vacuum line L2 to communicate the vacuum line L2 to the outside so as to protect the vacuum line L2 when a vacuum pressure higher than a predetermined vacuum pressure is formed.

In addition, a check valve 25 may be installed on the vacuum line L2, the suction plate line L3, the second vacuum line L9, the bypass discharge line L10 below the first filter 21 and the discharge line L5 below the second filter 22 in a direction to prevent a reverse flow of the vacuum flow or the compressed air flow.

Hereinafter, detailed operations and control methods of the vacuum suction apparatus according to the present disclosure having above-described configurations will be described by way of exemplary embodiments.

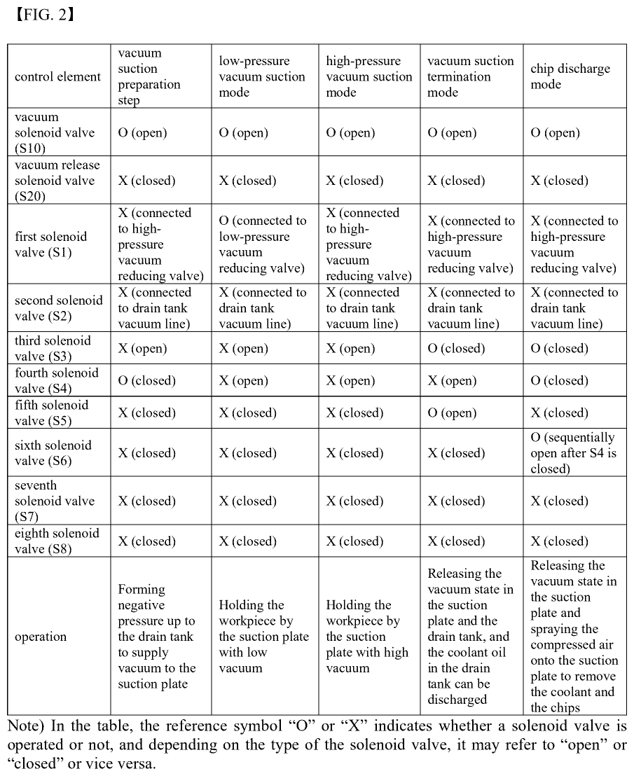

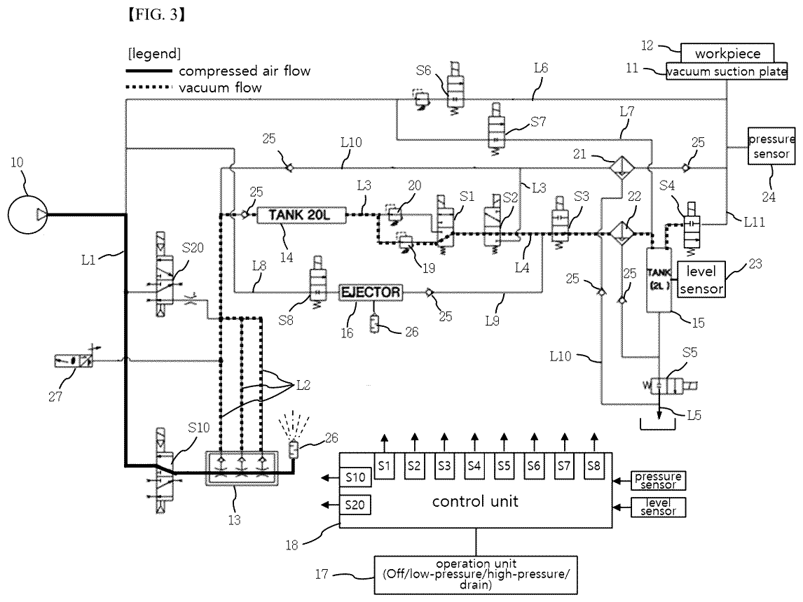

Referring to the control status table of the solenoid valves for each operating mode in FIG. 2 and the pneumatic circuit diagrams in FIGS. 3 through 7, the operation and control method for each control mode will be described below. Referring to the control status table of the solenoid valves for each operation mode of FIG. 2 and pneumatic circuit diagrams of FIGS. 3 to 7, each operation and control method for operation modes are described as follows.

### <Preparation Step for Vacuum Suction Operation>

The preparation step for a vacuum suction is a stage for preparing an operation of the vacuum suction apparatus. When power is turned on through the operating unit 17, the control unit 18 is configured to control the solenoid valves arranged in the pneumatic circuit that constitutes the vacuum suction apparatus as follows.

Referring to FIGS. 2 and 3, in the preparation step for the vacuum suction, the vacuum release solenoid valve S20 installed on the compressed air line L1 is closed (Off) while the pneumatic pump 10 is in an operating state, and the vacuum solenoid valve S10 is opened (On) so that the compressed air is discharged to the outside through the vacuum generator 13, thereby generating negative pressure in the vacuum generator 13. Accordingly, the negative pressure generated in the vacuum generator 13 lowers an internal pressure of the vacuum tank 14 through the vacuum line L2 to make a negative pressure state. At this time, the negative pressure on the vacuum line L2 is lowered to an allowable vacuum pressure of the relief valve 27 installed on the vacuum line L2.

In addition, the first solenoid valve S1 installed on the suction plate line L3 that connects the vacuum tank 14 and the suction plate 11 is in an inoperative (Off) state so that the suction plate line L3 is communicated with the vacuum tank 14 through the high-pressure vacuum reducing valve 19.

Additionally, the second solenoid valve S2 is also in an inactive (Off) state such that the suction plate line L3 is communicated with the drain tank vacuum line L4 connected to the drain tank 15. Meanwhile, the third solenoid valve S3 installed on the drain tank vacuum line L4 between the second solenoid valve S2 and the drain tank 15, is opened (Off) state, so that the drain tank 15 is connected with the drain tank vacuum line L4.

The fourth solenoid valve S4 installed on the drain line L11 that connects the drain tank 15 and the suction plate 11 is in a closed (On) state to close the drain line L11.

Meanwhile, the fifth solenoid valve S5 installed on the discharge line L5 that is communicably provided with the outside below the drain tank (15) to connect the drain tank 15 to the outside, the sixth solenoid valve S6 installed on the unclamp line L6 connected to the compressed air line L1, the seventh solenoid valve S7 installed on the drain pressure line L7 that is branched from the compressed air line L1 and connected to the drain tank 15, and the eighth solenoid valve S8 installed on the ejector line L8 that is branched from the compressed air line L1 and connected to the ejector 16 is maintained in a closed (Off) state.

Therefore, the preparation step for the vacuum suction forms a negative pressure state only up to the vacuum tank 14 via the vacuum line L2, the high-pressure vacuum reducing valve 19 on the suction plate line L3, the first solenoid valve S1, the second solenoid valve S2, and the drain tank 15 via the drain tank vacuum line L4 using the negative pressure generated in the vacuum generator 13.

### <Low-Pressure Suction Mode>

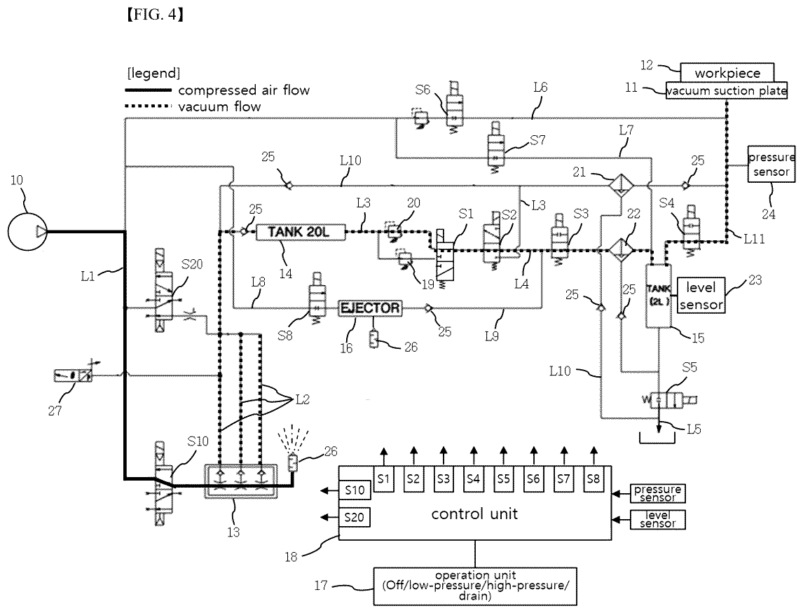

Referring to FIGS. 2 and 4, when a low-pressure suction is selected through the operation unit 17, in a state that the solenoid valves have been controlled as in the preparation step described above, i.e., while the vacuum is formed only up to the vacuum tank 14 and the drain tank 15 below the suction plate 11 to form a vacuum in the suction plate 11, the control unit 18 is configured to additionally control the solenoid valves of the vacuum suction apparatus as follows.

The first solenoid valve S1 installed on the suction plate line L3 that connects the vacuum tank 14 and the suction plate 11 is switched to an operating (On) state, and the suction plate line L3 is then switched to a state to be connected to the low-pressure vacuum pressure reducing valve 20. As the suction plate line L3 is connected to the low-pressure vacuum pressure reducing valve 20, the pressure of the suction plate line L3 is maintained at the low-pressure vacuum pressure within a range permitted by the low-pressure pressure reducing valve 20.

In addition, the fourth solenoid valve S4 installed on the drain line L11 that connects the drain tank 15 and the suction plate 11 is switched to an open (Off) state to communicate the drain L11 with the drain tank 15.

Accordingly, a low-pressure vacuum formed through the vacuum tank 14 and the drain tank 15 is applied to the suction plate 11 through the drain line L11, so that the suction plate 11 suctions and holds the workpiece 12 with the low-pressure vacuum.

### <High-Pressure Suction Mode>

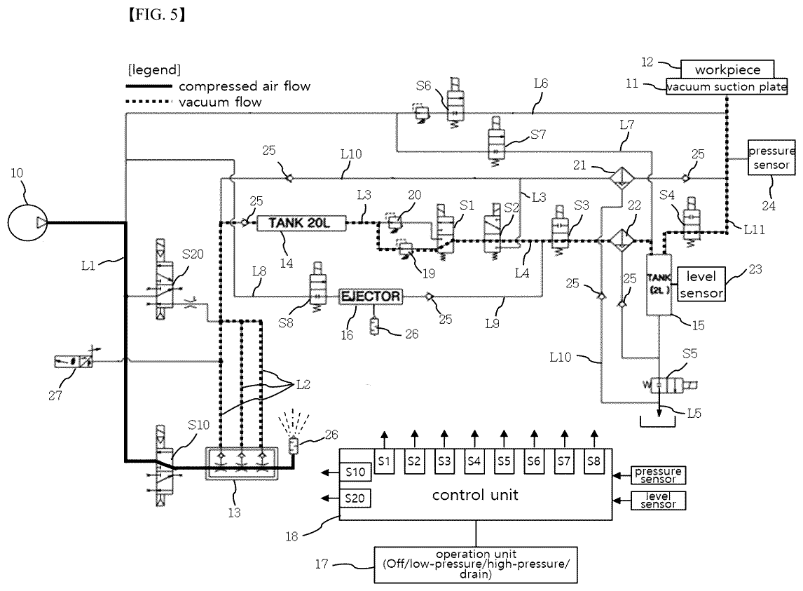

Referring to FIGS. 2 and 5, when a high-pressure suction is selected through the operation unit 17, in a state that the solenoid valves have been controlled as in the preparation step described above, i.e., while a high-pressure vacuum is formed only up to the vacuum tank 14 and the drain tank 15 below the suction plate 11 to form a vacuum in the suction plate 11, the control unit 18 is configured to additionally control the solenoid valves of the vacuum suction apparatus as follows.

The fourth solenoid valve S4 installed on the drain line L11 that connects the drain tank 15 and the suction plate 11 is switched to an open (Off) state, and the high-pressure vacuum pressure of the vacuum tank 14 and the drain tank 15 is applied to the suction plate 11 through the drain line L11 to hold the workpiece 12 with the high-pressure vacuum.

At this time, since the vacuum tank 14 is connected to the suction plate 11 through the high-pressure vacuum reducing valve 19 on the suction plate line L3, a high-pressure vacuum equal to a preset vacuum pressure of the high-pressure vacuum reducing valve 19 is applied to the suction plate 11.

### <Suction Termination Mode>

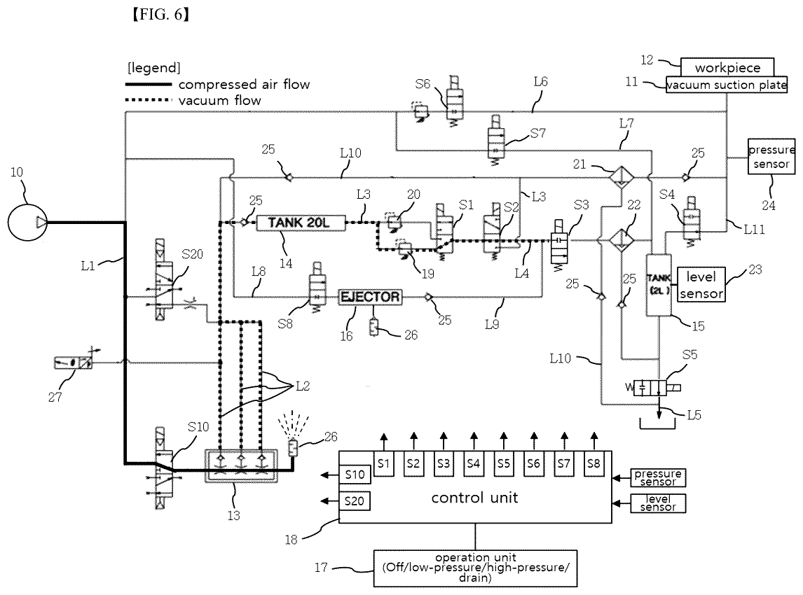

Referring to FIGS. 2 and 6, when a low-pressure suction is terminated through the operation unit 17, in a state that the solenoid valves have been controlled as in the low-pressure auction mode described above, the control unit 18 is configured to additionally control the solenoid valves of the vacuum suction apparatus as follows.

The third solenoid valve S3 installed on the drain tank vacuum line L4 between the second solenoid valve S2 and the drain tank 15 is switched to the closed (On) state, so that the drain tank vacuum line L4 that has been providing a vacuum pressure from the vacuum tank 14 to the drain tank 15 is disconnected (closed).

Therefore, the vacuum pressure, which has been supplied to the drain tank 15 and the suction plate 11 through the vacuum tank 14, is no longer applied on the suction plate 11, so that the suction plate 11 releases its vacuum suction and hold function for the workpiece 12.

Furthermore, the fifth solenoid valve S5 installed in the discharge line L5 below the drain tank 15 is switched to the open (On) state, so that the drain tank 15 is communicated with the outside through the discharge line L5 and is turned into an atmospheric pressure state, and foreign substances such as the coolant oil or the like collected in the drain tank 15 can be discharged to the outside through the discharge line L5.

In another embodiment of the present disclosure, the suction termination mode is automatically performed by the control unit 18 even when the high-pressure suction mode is terminated.

### <Chip Discharge Mode>

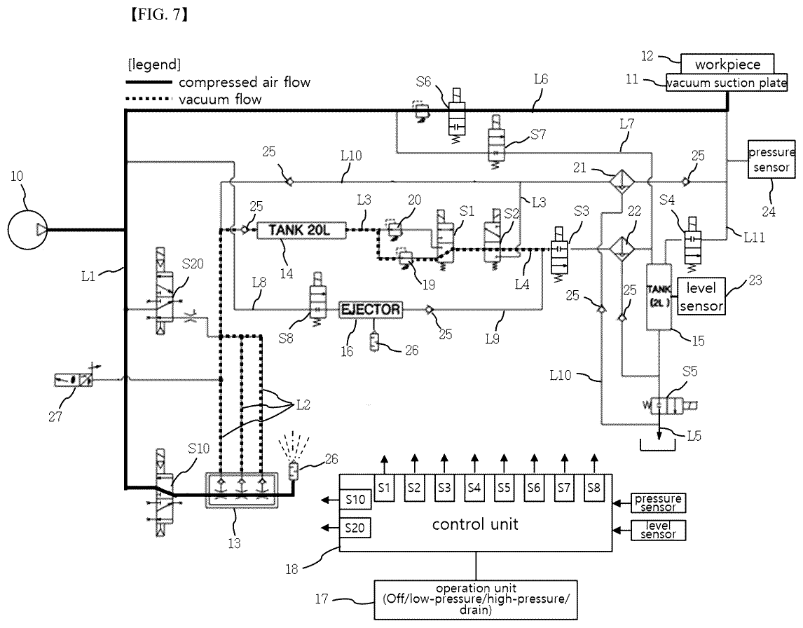

Referring to FIGS. 2 and 7, when a high-pressure suction is terminated through the operation unit 17, in a state that the solenoid valves have been controlled as in the high-pressure auction mode described above, the control unit 18 is configured to additionally control the solenoid valves of the vacuum suction apparatus as follows.

The fourth solenoid valve S4 installed on the drain line L11 that connects the drain tank 15 and the suction plate 11 is switched to a closed (On) state, and the vacuum pressure that has been applied to the suction plate 11 through the drain tank 15 is blocked, so that the suction plate 11 no longer suctions and holds the workpiece 12 in a negative pressure state.

In addition, the fifth solenoid valve S5 installed in the discharge line L5 to communicate the drain tank 15 with the outside is switched to a closed (Off) state, so that the discharge line L5 below the drain tank 15 is disconnected (closed) with the outside. Accordingly, the foreign substances such as the coolant oil or the like collected in the drain tank 15 cannot be discharged to the outside through the discharge line L5. Moreover, since the discharge line L5 is closed, the compressed air cannot be also discharged through the discharge line L5.

Meanwhile, the sixth solenoid valve S6 installed on the unclamp line L6 that connects the compressed air line L1 and the suction plate 11 is switched to an open (On) state after a predetermined period of time has elapsed after the fourth solenoid valve S4 is closed. Accordingly, the compressed air in the compressed air line L1 is sprayed onto both the suction plate 11 and the workpiece 12 through the unclamp line L6, such that the coolant oil and chips remaining on the suction plate 11 are scattered and removed therefrom.

In the chip discharge mode as such, while the compressed air is sprayed onto the suction plate 11, the drain tank 15 which suctions the chips or the coolant oil from the workpiece 12 by vacuum from the suction plate 11 is configured to stop its suction function, and leakage of the compressed air through the drain tank 15 also does not occur.

In another embodiment of the present disclosure, the chip discharge mode is automatically performed by the control unit 18 even when the low-pressure suction mode is terminated.

### <Drain Operation

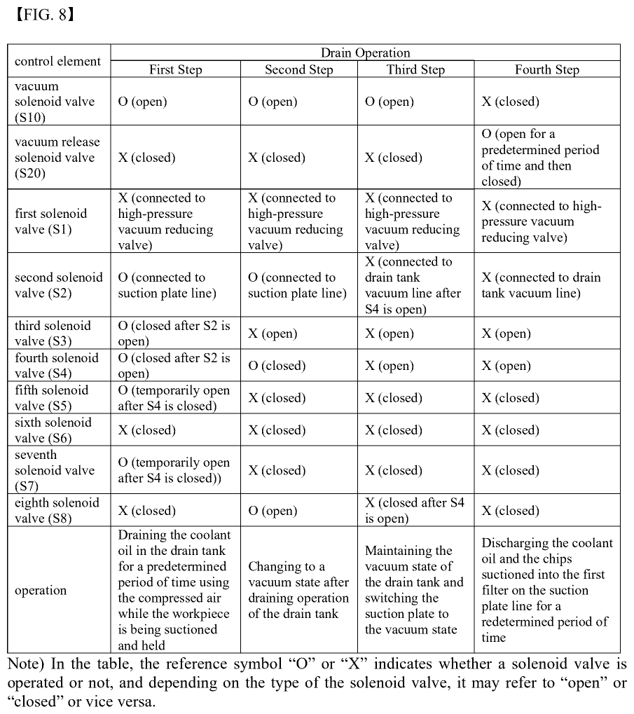

The drain operation of the vacuum suction apparatus will be described hereinafter with reference to FIGS. 8 to 12. The drain operation is performed by selecting either the low-pressure suction mode or the high-pressure suction mode through the operating unit 17, in which the solenoid valves are switched accordingly to allow the suction plate 11 to suction the workpiece 12 to perform machining operations. Then, a portion of the coolant oil including the chips from the suction plate 11 is introduced into the drain tank 15 via the drain line L11.

Here, when an amount of the coolant oil discharged into the drain tank 15 detected by the level sensor 23 installed in the drain tank 15 reaches a predetermined amount, the control unit 18 is configured to automatically execute a drain operation by controlling the solenoid valves as follows to discharge the coolant oil in the drain tank 15.

Meanwhile, the drain operation can be performed by the operator arbitrarily inputting a drain command through the operation unit 17 regardless of the level sensor 23 of the drain tank 15.

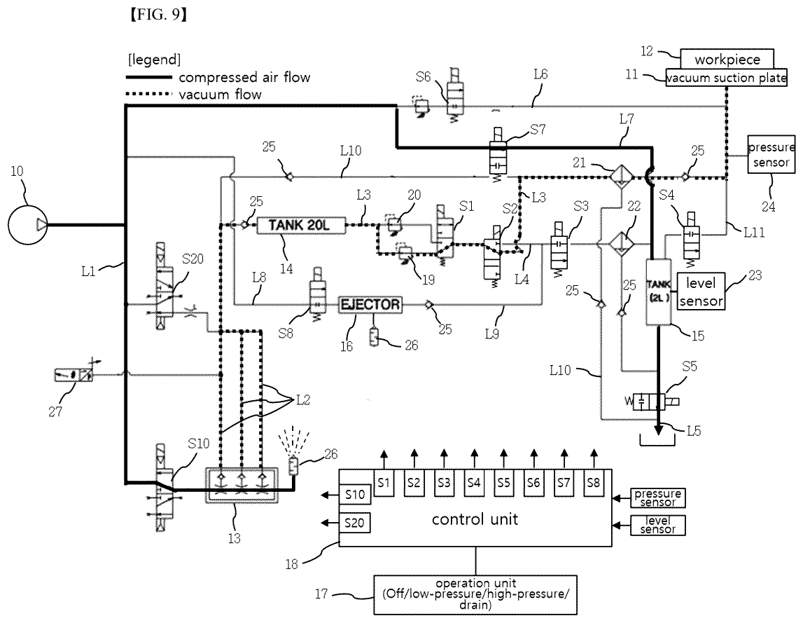

Referring to FIGS. 8 and 9, when a low-pressure suction mode is currently in effect, for a first-step drain operation, the control unit 18 is configured to switch the first solenoid valve S1, which is installed on the suction plate line L3 that connects the vacuum tank 14 and the suction plate 11, to an inoperative (Off) state and allows the suction plate line L3 to be communicated with the high-pressure vacuum reducing valve 19.

Further, the second solenoid valve S2 installed on the suction plate line L3 that connects the first solenoid valve S1 and the suction plate 11 is switched to an open (On) state to allow the high-pressure reducing valve 19 to be communicated with the suction plate line L3.

Then, after a predetermined time has elapsed after the second solenoid valve S2 operates, the third solenoid valve S3 installed on the drain tank vacuum line L4 that connect the second solenoid valve S2 and the drain tank 15 becomes a closed (On) state.

Accordingly, the suction plate 11 is blocked from receiving the vacuum pressure from the vacuum tank 14 through the drain tank vacuum line L4, and instead maintains a high-pressure vacuum state through the vacuum tank 14, the first solenoid valve S1 including the high-pressure vacuum reducing valve 19, the second solenoid valve S2, and the suction plate line L3, thereby maintaining the workpiece 12 in a suction state.

Meanwhile, the fourth solenoid valve S4 is closed (On), so that operations of suctioning the foreign substances such as the coolant oil from the suction plate 11 and discharging the same into the drain tank 15 through the drain line L11 are stopped.

On the other hand, the fifth solenoid valve S5 becomes an open (On) state, and the foreign substances such as the coolant oil within the drain tank 15 can be discharged through the discharge line L5.

In addition, the sixth solenoid valve S6 that connects the compressed air line L1 and the suction plate 11 through the unclamp line L6 is closed (Off), and the seventh solenoid valve S7 installed on the drain pressurized line L7 that is branched from the compressed air line L1 and connected to the drain tank 15 is open after a predetermined time has elapsed after the fourth solenoid valve S4 is closed, thereby supplying the compressed air to the drain tank 15 and rapidly discharging the coolant oil within the drain tank 15 to the outside through the discharge line L5.

At this time, since the seventh solenoid valve S7 is to open only for a predetermined period of time and then closed, the compressed air to be supplied to the drain tank 15 will be supplied only for the predetermined period of time, such that the foreign substances such as the coolant oil within the drain tank 15 are then discharged to the outside through the discharge line L5.

Meanwhile, in another embodiment of the present disclosure, in the first-step drain operation, the control unit 18 is configured to switch the first solenoid valve S1 to an open (On) state to provide a low-pressure vacuum to the suction plate line L3 through the low-pressure vacuum reducing valve 20, and allows the suction plate 11 to suction the workpiece 12 in a low-pressure vacuum state, thereby safely holding the workpiece 12 without damage whose surface is easily damaged thereto.

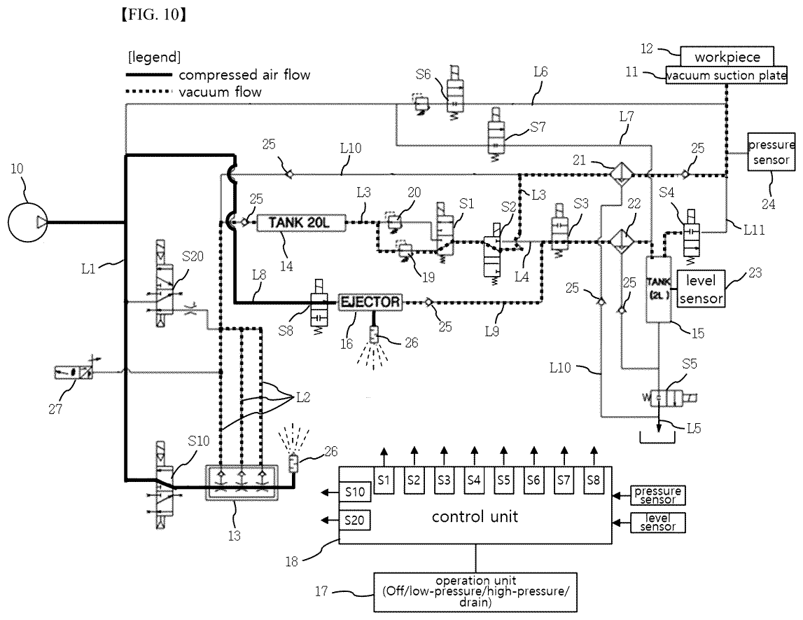

Next, a second-step drain operation is described by referring to FIGS. 8 and 10. The second-step drain operation is an operation to change the drain tank 15 back to a vacuum state for a predetermined period of time after completing the discharge operation of the foreign substances such as the coolant oil within the drain tank 15 through the above-mentioned first-step drain operation. Preferably, the second-step drain operation is performed for about 5 seconds after closing the discharge line L5 in which the fifth solenoid valve S5 is installed.

More specifically, the second-step drain operation is performed in a state where the solenoid valves have been switched to complete the first-step drain operation, in which the third solenoid valve S3 is switched to an open (Off) state, and the drain tank 15 is connected to an ejector 16 having a negative pressure function through the second vacuum line L9.

In addition, the fifth solenoid valve S5 is switched to a closed (Off) state, and the discharge operation of the coolant oil from the drain tank 15 through the discharge line L5 is stopped. At the same time, the seventh solenoid valve S7 is also switched to a closed (Off) state, such that supply of the compressed air to the drain tank 15 through the drain pressurized line L7 becomes stopped.

In addition, the eighth solenoid valve S8 installed in the ejector line L8 that is branched from the compressed air line L1 and is connected to the ejector 16 is switched to an open (On) state to supply the compressed air to the ejector 16.

Hence, the compressed air supplied to the ejector 16 is discharged to the outside from the ejector 16 that performs a negative pressure function, generates a negative pressure in the second vacuum line L9 connected to the ejector 16, and provides the negative pressure in the second vacuum line L9 to the drain tank 15 through the third solenoid valve S3 being opened.

Therefore, the drain tank 15 is changed to a vacuum state for a predetermined period of time after the discharge operation of the foreign substances such as the coolant oil is completed.

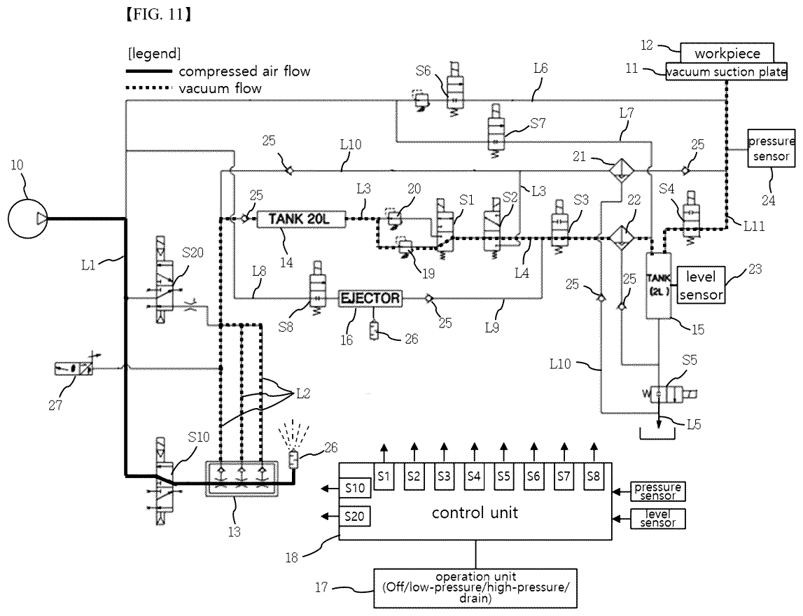

Next, referring to FIGS. 8 and 11, a third-step drain operation is a process for completing the draining operation, in which after the drain tank 15 is changed to a vacuum state by the ejector 16 in the second drain operation, the drain tank 15 is connected to the vacuum tank 14 to maintain a collecting function of the coolant oil in the drain tank 15 and a vacuum suction function of the suction plate 11 via the drain tank 15.

Specifically, the third-step drain operation is performed in a state where the solenoid valves have been switched to the second-step drain operation completion state, in which the first solenoid valve S1 and the second solenoid valve S2 installed on the suction plate line L3 are switched to communicate (Off) the vacuum tank 14 and the drain tank vacuum line L4. Therefore, the drain tank 15 receives a negative pressure through the vacuum tank 14 and becomes a vacuum state which is capable of collecting the coolant oil and the fine chips from the suction plate 11 through the drain line L11.

Meanwhile, the second solenoid valve S2 is then sequentially opened after a predetermined time after the fourth solenoid valve S4 is opened (Off), as described later, thereby reducing shocks and noises due to a vacuum state transition of the drain tank 15.

In addition, the fourth solenoid valve S4 installed on the drain line L11 that connects the suction plate 11 and the drain tank 15 is switched to an open (Off) state, such that the suction plate 11 and the drain tank 15 are connected in a negative pressure state through the drain line L11.

Accordingly, the suction plate 11 suctions the workpiece 12 with the vacuum pressure, and at the same time, the foreign substances such as the coolant oil generated from the suction plate 11 can be discharged into the drain tank 15 through the drain line L11.

In addition, the eighth solenoid valve S8 installed in the ejector line L8 that is branched from the compressed air line L1 and is connected to the ejector 16 is switched to a closed (Off) state, such that a supply of the compressed air to the ejector 16 is blocked. As the supply of the compressed air to the ejector 16 is blocked, a negative pressure generation function of the ejector 16 is stopped, and as a result, a negative pressure function of the second vacuum line L9 connected to the ejector 16 is also lost, such that the drain tank 15 receives a negative pressure only from the vacuum tank 14.

Meanwhile, the eighth solenoid valve S8 is then sequentially opened after a predetermined time after the fourth solenoid valve S4 is opened (Off), thereby reducing shocks and noises caused by the vacuum state transition of the drain tank 15.

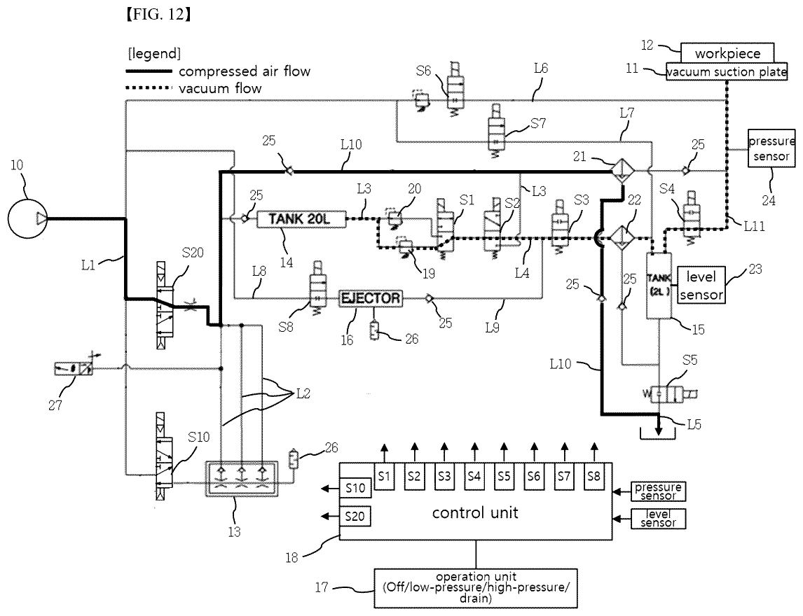

Next, referring to FIGS. 8 and 12, a fourth-step drain operation is a process for discharging the foreign substances including the coolant oil that are collected in the first filter 21 installed on the suction plate line L3 between the second solenoid valve S2 and the suction plate 11 after completing the third drain operation. In a state where the solenoid valves have been switched to the third-step drain operation, the vacuum solenoid valve S10 installed on the compressed air line L1 between the pneumatic pump 10 and the vacuum generator 13 is switched to a closed (Off) state to disconnect a flow of the compressed air being supplied to the vacuum generator 13, thereby blocking the negative pressure to be applied to the vacuum tank 14 through the vacuum line L2.

Simultaneously, the vacuum release solenoid valve S20 installed between the compressed air line L1 and the bypass discharge line L10 is opened (On), such that the compressed air is supplied to the first filter 21 installed on the suction plate line L3 that is connected to the bypass discharge line L10. Accordingly, the foreign substances including the coolant oil collected in the first filter 21 are discharged to the outside through the bypass discharge line L10 that is extended to a lower portion of the first filter 21 to be communicated with the discharge line L5.

Meanwhile, the vacuum release solenoid valve S20 is opened only for a predetermined time and then closed, such that a drain operation of the first filter 21 using the compressed air is temporally performed, thereby not interfering with a suction operation for the workpiece 12 that is an original function of the vacuum suction apparatus.

However, in a case that the suction plate 11 is not in a state of suctioning and holding the workpiece 12, that is, if the operator arbitrarily executes the drain operation in a state other than the low-pressure suction mode or the high-pressure suction mode, the fourth-step drain operation is not performed.

Meanwhile, in another exemplary embodiment of the present disclosure, the seventh solenoid valve S7 and the eighth solenoid valve S8 in the above-mentioned embodiments, that are components involved in the drain operation of the coolant oil or the foreign substances collected in the drain tank 15 to the outside, can be arbitrarily operated by a separate manual operation means without being linked to the control unit 18.

Furthermore, in some cases, the drain pressure line L7, the ejector line L8, the second vacuum line L9 and the ejector 16 that are related to the seventh solenoid valve S7 and the eighth solenoid valve S8 is not be installed. Instead, an operation time of the fifth solenoid valve S5 installed in the discharge line L5 is made longer, and a flow path area of the discharge line L5 and the fifth solenoid valve S5 is made larger to be capable of passing through the coolant oil and the foreign substances, thereby performing a function of discharging the foreign substances collected in the drain tank 15.

As described in the above exemplary embodiments of the present disclosure, it would be noted that a precision workpiece 12 with a high surface roughness can be securely suctioned and held in a vacuum suction manner using the negative pressure.

Furthermore, types and shapes of the workpiece 12 to be held can be varied by adjusting a suction pressure as needed.

In addition, the foreign substances such as the coolant oil or the fine chips that are generated during the machining process of the workpiece 12 are effectively removed to prevent damage to the workpiece 12, and further prevent the same from being suctioned into the vacuum suction apparatus to deteriorate its performance or to cause damage thereto.

As described above, while the present disclosure has been explained with reference to preferred exemplary embodiments thereof, it will be understood by those skilled in the art that various modifications and changes may be made to the present disclosure without departing from the spirit and scope of the present disclosure as set forth in the claims below.

### Explanation of Signs

10: pneumatic pump
11: suction plate
12: workpiece
13: vacuum generator
14: vacuum tank
15: drain tank
16: ejector
17: operation unit
18: control unit
19: high-pressure vacuum reducing valve
20: low-pressure vacuum pressure reducing valve
21: first filter
22: second filter
23: level sensor
24: pressure sensor
25: check valve
26: silencer
27: relief valve
S10: vacuum solenoid valve
S20: vacuum release solenoid valve
S1: first solenoid valve
S2: second solenoid valve
S3: third solenoid valve
S4: fourth solenoid valve
S5: fifth solenoid valve
S6: sixth solenoid valve
S7: seventh solenoid valve
S8: eighth solenoid valve
L1: compressed air line
L2: vacuum line
L3: suction plate line
L4: drain tank vacuum line
L5: discharge line
L6: unclamp line
L7: drain pressure line
L8: ejector line
L9: second vacuum line
L10: bypass discharge line
L11: drain line

1. A vacuum suction apparatus for a machine tool, the apparatus comprises:
a suction plate that suctions a workpiece using a vacuum pressure;
a pneumatic pump that supplies compressed air through a compressed air line;
a vacuum generator that generates negative pressure by discharging the compressed air to an outside at one end portion of the compressed air line;
a vacuum solenoid valve that is installed on the compressed air line between the pneumatic pump and the vacuum generator to selectively connect or disconnect a flow path of the compressed air to be supplied to the vacuum generator;
a vacuum tank having an internal volume and connected to the vacuum generator through a vacuum line;
a first solenoid valve installed on a suction plate line that connects the vacuum tank and the suction plate, and configured to selectively connect the suction plate line to a high-pressure vacuum or a low-pressure vacuum;
a drain tank connected to the suction plate through a drain line to collect coolant oil and fine chips from the suction plate using the vacuum pressure;
a second solenoid valve installed on the suction plate line that connects the first solenoid valve and the suction plate, and configured to selectively connect the suction plate line to the suction plate or the drain tank;
a third solenoid valve installed on a drain tank vacuum line that connects the second solenoid valve and the drain tank, and configured to connect or disconnect the drain tank vacuum line;
a fourth solenoid valve installed on a drain line that connects the suction plate and the drain tank, and configured to selectively connect or disconnect the drain line;
a fifth solenoid valve installed on a discharge line that connects the drain tank to the outside, and configured to selectively connect or disconnect the discharge line;
a sixth solenoid valve installed on an unclamp line that connects the compressed air line to the suction plate, and configured to selectively connect or disconnect the unclamp line;
a vacuum release solenoid valve installed between the vacuum line and the compressed air line, and configured to connect the vacuum line with the discharge line through a bypass discharge line and simultaneously with the compressed air line, and selectively connect or disconnect the compressed air line and the vacuum line;
a control unit electrically connected to the first to sixth solenoid valves and the vacuum release solenoid valve, respectively, and configured to connect or disconnect a flow of the compressed air or the vacuum pressure, or to change a flow direction thereof by switching the said solenoid valves; and
an operating unit that provides an operating command to the control unit.

2. The apparatus of claim 1, wherein a high-pressure vacuum pressure reducing valve that connects the suction plate line with the vacuum tank to form a high-pressure vacuum, and a low-pressure vacuum pressure reducing valve that connects the suction plate line with the vacuum tank to form a low-pressure vacuum depending on a switching position of the first solenoid valve are respectively installed on the suction plate line between the vacuum tank and the first solenoid valve.

3. The apparatus of claim 1, wherein a first filter that collects the coolant oil and the fine chips suctioned from the suction plate through the suction plate line is installed on the suction plate line between the second solenoid valve and the suction plate, wherein a lower portion of the first filter is connected to the discharge line connected to the outside through the bypass discharge line.

4. The apparatus of claim 1, wherein a second filter that collects the coolant oil and the fine chips is installed on the drain tank vacuum line that connects the third solenoid valve and the drain tank, wherein a lower portion of the second filter is connected to the discharge line to be selectively connected to the outside.

5. The apparatus of claim 4, wherein the lower portion of the second filter is connected to an upstream side of the fifth solenoid valve that selectively connects or disconnects the discharge line to the outside.

6. The apparatus of claim 1, wherein the fourth solenoid valve closes the drain line connected to the suction plate to maintain a vacuum pressure formed in the suction plate when the drain tank is communicated to the outside through the fifth solenoid valve.

7. The apparatus of claim 1, wherein the fifth solenoid valve closes the discharge line to maintain a vacuum pressure in the drain tank while the drain tank collects the coolant oil and the fine chips from the suction plate through the drain line, and when discharging the coolant oil and the fine chips collected in the drain tank to the outside, the fifth solenoid valve connects the discharge line to the outside so that the collected coolant oil and the fine chips are discharged to the outside by the compressed air applied to the drain tank.

8. The apparatus of claim 1, wherein the sixth solenoid valve is opened (connected) when the compressed air is sprayed to remove the foreign substances from the suction plate while the vacuum pressure is released from the suction plate, and is closed (disconnected) when the vacuum pressure is formed in the suction plate.

9. The apparatus of claim 1, further comprising:
a seventh solenoid valve installed on a drain pressurized line that connects the compressed air line and the drain tank, and configured to selectively connect or disconnect the drain pressurized line;
an ejector connected to the compressed air line through an ejector line, and configured to discharge the compressed air to the outside to generate negative pressure and to supply the generated negative pressure to the drain tank vacuum line through a second vacuum line; and
an eighth solenoid valve installed on the ejector line to selectively connect or disconnect the ejector line

10. The apparatus of claim 9, wherein when discharging the coolant oil and the foreign substances collected in the drain tank, the seventh solenoid valve connects the drain pressurized line with the compressed air line so that the compressed air supplied from the compressed air line is applied to the drain tank, and when forming a vacuum pressure in the drain tank, the seventh solenoid valve disconnects the drain pressurized line from the compressed air line.

11. The apparatus of claim 9, wherein when a negative pressure is generated in the ejector, a second vacuum line applies the negative pressure to the drain tank vacuum line, thereby forming or maintaining the negative pressure in the drain tank connected to the drain tank vacuum line.

12. The apparatus of claim 9, wherein a silencer is installed in the vacuum generator and the ejector to reduce noise generated by the compressed air being discharged.

13. The apparatus of claim 1, wherein the control unit and the operation unit comprise at least a low-pressure suction mode that provides a low-pressure vacuum to the suction plate, a high-pressure suction mode that provides a high-pressure vacuum to the suction plate, a chip discharge mode that sprays the compressed air to the suction plate, and a suction termination mode that blocks the vacuum pressure being applied to the suction plate to terminate a workpiece suction operation.

14. The apparatus of claim 1, wherein the operation unit further includes a drain mode that discharges the foreign substances collected in the drain tank.

15. The apparatus of claim 14, wherein the drain mode includes an automatic mode that is automatically executed in a suction mode of the workpiece using the vacuum and a manual mode that is executed by manually operating the operation unit.

16. The apparatus of claim 1, wherein a level sensor is installed in the drain tank to detect a flow rate of the collected coolant oil and provide the same to the control unit, and the control unit is configured to control a drain operation to automatically discharge the coolant oil in the drain tank in a case that the flow rate of the coolant oil provided from the level sensor reaches a predetermined flow rate.

17. The apparatus of claim 1, wherein a pressure sensor is installed on the suction plate line connected to the suction plate or the drain line to detect a vacuum pressure formed in the suction plate and to provide the same to the control unit, and the control unit is configured to stop an operation of the pneumatic pump in a case that the vacuum pressure provided from the pressure sensor reaches a predetermined vacuum pressure.

18. The apparatus of claim 1, wherein a relief valve is installed on the vacuum line to connect the vacuum line to the outside to protect the vacuum line in a case that a vacuum pressure greater than a predetermined vacuum pressure is formed in the vacuum line.

19. The apparatus of claim 9, wherein a check valve is installed on the vacuum line, the suction plate line, the second vacuum line, and the bypass discharge line to prevent a reverse flow of the vacuum or the compressed air.
